(19) United States
(12) Patent Application Publication
(10) Pub. No.: US 2005/0224535 A1
(43) Pub. Date: Oct. 13, 2005

(54) Carrier for supporting an infant on a hip

(76) Inventor: Cammi A. Bruton, Van Alstyne, TX (US)

Correspondence Address: MICHAEL L. DIAZ, P.C., 555 REPUBLIC DRIVE, SUITE 200, PIANO, TX, 75074, US

(21) Appl. No.: 10/821,095

(22) Filed: Apr. 8, 2004

(51) Int. Cl. A61G 1/00; A61G 5/00; A44C 5/14

(52) U.S. Cl. 224/169

(57) ABSTRACT

An apparatus for carrying an infant upon the hip of an individual is disclosed. The apparatus includes a harness for supporting the infant. The apparatus also includes a far shoulder strap supported by one shoulder of the individual. The far shoulder strap has a front section resting on the chest region of the individual and a back section resting on a back region of the individual. The apparatus also includes a second near shoulder strap supported by the other shoulder of the individual. Each shoulder strap may include a pad for placement upon the shoulder to provide comfort while supporting the weight of the infant. The infant rests upon the hip of the individual. Both shoulders and one hip of the individual support the weight of the infant.

### BACKGROUND OF THE INVENTION

1. Field of the Invention

This invention relates to infant carriers. Specifically, the present invention relates to an apparatus for carrying an infant on a hip of an adult.

2. Description of the Related Art

As is known to most parents, infants need to be carried when traveling. However, after approximately the first six months, carrying an infant can be difficult. The infant becomes quite heavy and tends to move around quite a bit. To assist parents in carrying their young children, infant carriers are used to carry and support an infant. Existing infant carriers are available in a wide variety of configurations. One type of infant carrier is a backpack where the infant is carried upon the back of an adult. This type of carrier suffers from several disadvantages. First, the infant is positioned on the adult's back and therefore it is very difficult for the adult to see the infant. Second, for infants over six months, the backpack type carrier is not comfortable for the infant to be carried. The full weight of the infant rides in a harness, which puts considerable pressure on the infant's waste and crotch region.

Another type of existing carrier is a sling carrier, which typically includes one strap wrapped around a shoulder of the carrying adult. The infant is precariously held in a piece of material in a manner similar to a person lying in a hammock. Some of these sling-configured carriers also enable the infant to rest upon the adult's hip. However, this sling carrier does not provide adequate support to an infant. Specifically, the infant leans back (away from the adult) in the sling. This increases the chances that the infant may fall out of the sling backwards. Therefore, the adult must continuously hold their am around the back of the infant for additional support. In addition, since the infant is merely lying on a piece of material in a hammock-like fashion, the infant is not safely carried within the sling. The infant can easily fall out of such a sling-configured carrier. The danger to an infant is magnified with an infant able to sit up on his own and move (i.e., an infant older than six months).

Still another type of existing carrier is a front pack type carrier. With front pack type carriers, another disadvantage is the difficulty in wearing and adjusting the carrier. The adult typically must unbuckle and buckle one or more straps, which can be very difficult when tending to the needs of an infant. These carriers are very uncomfortable when carrying a baby weighing more than approximately 15 pounds. Considerable strain is placed on the back and shoulders of the adult using this type of carrier. Additionally, the infant is uncomfortably positioned within the carrier because the legs of the infant are left hanging straight down.

None of the existing infant carriers provide adequate support for an infant while enabling the infant to rest upon the carrying adult's hip. An apparatus is needed which enables an adult to comfortably and securely carry the infant upon the adult's hip. In addition, a carrier is needed which allows an adult to comfortably carry an infant weighing more than 15 pounds. Supporting an infant on the hip of the adult enables a majority of the infant's weight to be supported on the hip of the adult, rather than on the back of the adult.

Thus, it would be a distinct advantage to have an apparatus, which effectively and comfortably carries an infant on an adult's hip. It is an object of the present invention to provide such an apparatus.

### SUMMARY OF THE INVENTION

In one aspect, the present invention is an infant carrier for carrying an infant by an individual. The infant carrier includes a harness having two apertures and a back support for supporting the infant within the harness. The infant carrier also includes a near shoulder strap affixed to the harness and supported by one shoulder of the individual. In addition, a second far shoulder strap is affixed to the harness and supported by the other shoulder of the individual. The infant is carried along the hip of the individual and supported by the near shoulder strap upon the first shoulder and the far shoulder strap upon the second shoulder. The infant carrier may optionally be used to support the infant in a front seat of a shopping cart.

In another aspect, the present invention is an apparatus for carrying an infant. An individual wears the apparatus. The apparatus includes a harness supporting an infant. The harness includes two straps, each strap is supported by each shoulder of the individual. The infant is positioned upon the hip of the individual. Both shoulders and the hip of the individual support the weight of the infant.

In still another aspect, the present invention is an infant carrier for carrying an infant by an individual. The infant carrier includes a harness having two apertures and a back support for supporting the infant within the harness. A near shoulder strap is affixed to the harness and supported by the first shoulder of the individual. The near shoulder strap is adjustable in length. A second far shoulder strap is also affixed to the harness and supported by the other shoulder of the individual. The far shoulder strap is adjustable in length by the individual while carrying the infant. The far shoulder strap has a frontal section resting upon the chest region of the individual and a back region resting on a back region of the individual. The hip and shoulders of the individual support the infant.

### BRIEF DESCRIPTION OF THE DRAWINGS

FIG. 1 is a front perspective view of an infant carrier worn by an adult in the preferred embodiment of the present invention;

FIG. 2 is a side view of the infant carrier carrying the infant against the hip of the adult in the preferred embodiment of the present invention; and

FIG. 3 is a top plan view of the infant carrier detached from the adult.

### DESCRIPTION OF THE INVENTION

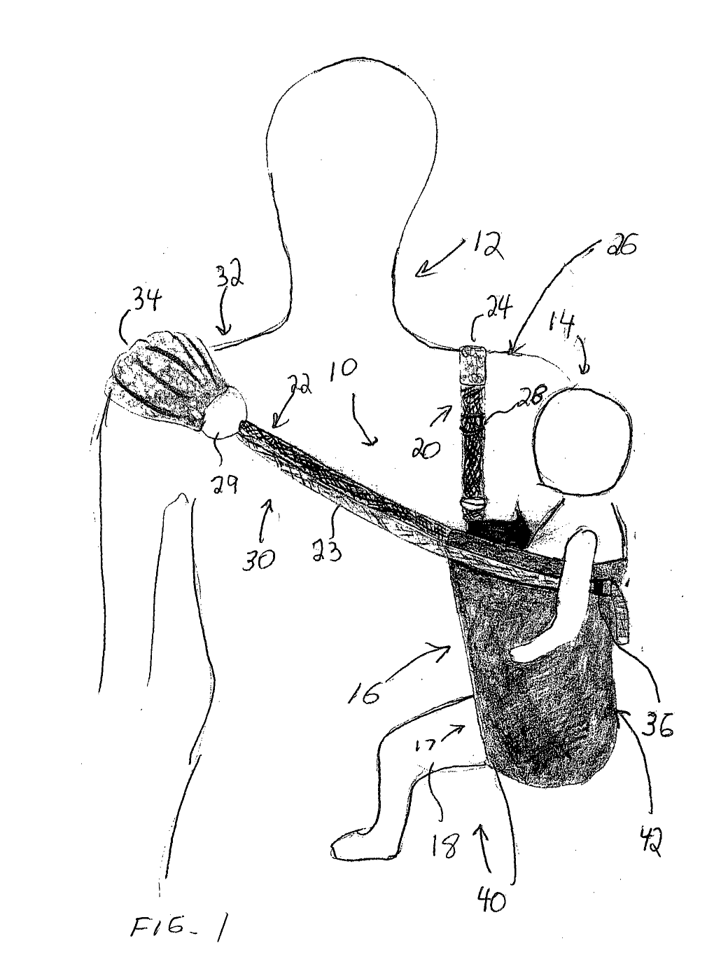

The present invention is an apparatus for carrying an infant upon an adult's hip. FIG. 1 is a front perspective view of an infant carrier 10 worn by an adult 12 in the preferred embodiment of the present invention. The infant carrier 10 carries an infant 14 in a harness 16. The body harness 16 includes two leg apertures 17 (one shown in FIG. 1) through which each leg 18 of the infant passes through. The harness 16 includes a near shoulder strap 20 and an opposite far shoulder strap 22.

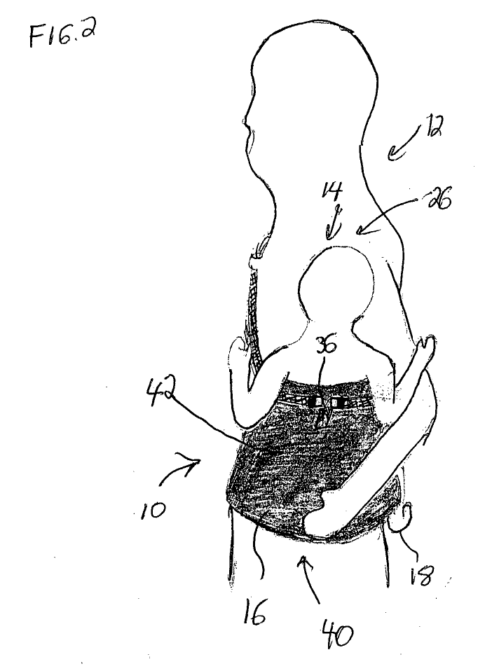

The near shoulder strap 20 may include a padded section 24 conforming to the shoulder 26 closest to the harness 16 and infant 14. Preferably, the padded section 24 is constructed of a flexible knit material to provide comfort to the adult 12. The near shoulder strap may also be optionally adjustable in length. The adjustability of the length of the near shoulder strap 20 may be accomplished by strap adjusters 28 (FIG. 2), allowing the lengthening or shortening of the near shoulder strap 20. The near shoulder strap 20 may be configured in any fashion, which allows the near shoulder 26 to bear a portion of the weight of the infant.

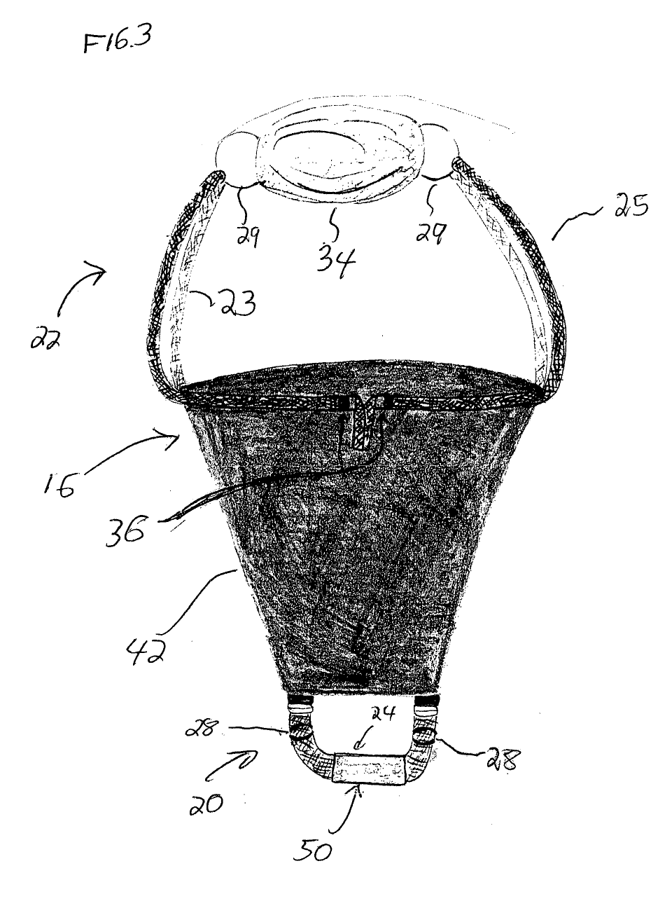

The far shoulder strap 22 includes a frontal chest section 23 crossing over the front of the chest 30 and a back section 25 (FIG. 3) crossing over the back of the adult 12 to rest upon the far shoulder 32. The far shoulder strap 22 preferably includes a widened section 34 resting upon the outermost portion of the far shoulder 32. The widened section 34 enables the far shoulder strap 22 to comfortably rest upon the far shoulder 32 (cup the shoulder) of the adult 12. Alternatively, the widened section 34 may included a padded area for the comfort of the adult. The far shoulder strap 22 may be adjustable in length. The adjustment of the length of the far shoulder strap may be by any configuration, such as an adjustment clip 36. Preferably, the adjustment clip is positioned on an outer surface 38 of the harness 16 on the back 40 of the infant 14. By positioning the adjustment clip 36 on the outside of the harness adjacent the back 40 of the infant, the adult 12 may adjust the length of the far shoulder strap while still carrying the infant in the harness 16. In the preferred embodiment of the present invention, the far shoulder strap 22 runs through a pair of o-rings 29 attached to opposite ends of the widened section 34. However, it should be understood that the far shoulder strap 22 may be configured in any fashion allowing the far shoulder 32 to bear a portion of the weight of the infant 14.

The harness 16 is preferably constructed of a flexible material such as cloth. The harness 16 is configured to enable the infant to sit upright in the harness with the legs 18 protruding through the apertures 17.

FIG. 2 is a side view of the infant carrier 10 carrying the infant 14 against the hip 40 of the adult 12 in the preferred embodiment of the present invention. The harness enables the infant to sit upright against a back portion 42 of the harness 16. The legs 18 run through the apertures 17. The legs straddle the side of the torso of the adult with the infant resting against the hip 40 of the adult. The configuration of the harness is designed so that the infant's legs assume a natural hip riding position, rather than just allowing the legs to hang straight down.

FIG. 3 is a top plan view of the infant carrier 10 detached from the adult 12. As illustrated in FIG. 3, the near shoulder strap 20 is shown resting downward to more fully show the infant carrier 10. The near shoulder strap 20 may optionally include an attachment section 50 for attachment to a front portion of a shopping cart. The attachment section may include excess material, which wraps around the front portion of the shopping cart while staying attached to the carrier.

With reference to FIGS. 1-3, the operation of the infant carrier 10 will now be explained. The infant carrier is worn by the adult 12 by positioning the far shoulder strap 22 upon the far shoulder 32. Preferably, the widened section 34 rests on the outmost portion of the shoulder 32. The near shoulder strap 20 rests upon the near shoulder 26. The padded sections prevent the straps from digging into the shoulders of the individual. The infant 14 is carried within the harness 16 in a conventional manner well known in harnesses. The infant's legs preferably straddle the side of the torso of the adult 12 in a hip-riding fashion. A portion of the weight of the infant is carried upon the hip 40 of the adult. If necessary, the near and far shoulder straps may be easily adjusted either with the infant in or out of the harness 16. The infant may be carried on either hip.

The infant carrier 10 may also be optionally utilized for securing the infant in the front seat of a shopping cart. The infant 14 is placed within the harness 16 and seated in the front seat of a conventional shopping cart. The attachment section 50 located on the near shoulder strap 20 is positioned in front of the infant. The attachment section is then attached to a portion of the shopping cart, such as the bar running transversely along the front of the shopping cart. The infant is then securely positioned in the front seat of the shopping cart, thereby preventing the infant from falling out of the seat.

The infant carrier may be configured in any fashion which utilizes two straps, one position on a portion of each shoulder of the adult carrier and allow transport of the infant upon the adult's hip. The straps may be constructed of any material allowing the safe support of the infant. The infant carrier 10, when not carrying an infant, may be folded and worn around the waist or shoulder of the individual.

The infant carrier 10 provides many advantages over existing devices. The present invention enables an adult to comfortably carry an infant upon her hip. The infant carrier 10 distributes the weight of the infant over two shoulders and the hip of the adult. In addition, the infant carrier enables the adult to easily adjust the straps while the infant is in the infant carrier. The infant is safely supported in the harness 16, which does not allow the infant to slip out of the carrier, as is a significant problem in existing infant carriers. The present invention also supports the infant in an upright sitting position, which is far more comfortable for an infant capable of sitting upright on his own. The infant carrier also enables carriage of the infant on either hip.

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

1. An infant carrier for carrying an infant by an individual, said infant carrier comprising:
a harness having two apertures and a back support for supporting the infant within the harness;
a near shoulder strap affixed to said harness, said near shoulder strap supported by the first shoulder of the individual; and
a far shoulder strap affixed to said harness, said far shoulder strap supported by the second shoulder of the individual;
the infant being supported along the hip of the individual and by said near shoulder strap upon the first shoulder and said far shoulder strap upon the second shoulder.

2. The infant carrier of claim 1 wherein said near shoulder strap includes a first adjusting means for adjusting the length of said near shoulder strap.

3. The infant carrier of claim 2 wherein said first adjusting means is accessible by the individual while carrying the infant.

4. The infant carrier of claim 3 wherein said first adjusting means is located on a section of said near shoulder strap resting upon a chest region of the individual.

5. The infant carrier of claim 1 wherein said near shoulder strap includes a padded area for placement on the first shoulder of the individual.

6. The infant carrier of claim 1 wherein said far shoulder strap includes a second adjusting means for adjusting the length of said far shoulder strap.

7. The infant carrier of claim 6 wherein the second adjusting means is accessible by the individual while carrying the infant.

8. The infant carrier of claim 7 wherein the second adjusting means is located on an outside surface of said harness.

9. The infant carrier of claim 1 wherein said far shoulder strap includes a widened area for placement and cupping on the second shoulder of the individual.

10. The infant carrier of claim 1 wherein the infant's legs are position in the apertures and the back of the infant lies against the back support.

11. The infant carrier of claim 1 further comprising means for attaching the infant carrier to a front seat of a shopping cart.

12. The infant carrier of claim 11 wherein the means for attaching the infant carrier to the front seat includes a connectable piece of material affixed to the near shoulder strap.

13. The infant carrier of claim 1 wherein said far shoulder strap includes a front section resting against the chest of the individual and a back section resting against a back section of the individual.

14. An infant carrier for carrying an infant, said infant carrier comprising:
an individual having shoulders;
a harness having two apertures and a back support for supporting the infant within said harness;
a near shoulder strap affixed to said harness, said near shoulder strap supported by the first shoulder of said individual; and
a far shoulder strap affixed to said harness, said far shoulder strap supported by the second shoulder of said individual;
the infant being supported along the hip of said individual and by said near shoulder strap upon the first shoulder and said far shoulder strap upon the second shoulder.

15. The infant carrier of claim 14 wherein said near shoulder strap is adjustable in length.

16. The infant carrier of claim 14 wherein said far shoulder strap is adjustable in length.

17. The infant carrier of claim 16 wherein said far shoulder strap is adjustable while the infant is in said harness.

18. The infant carrier of claim 14 wherein the infant's legs are positioned through the apertures and the back of the infant lies against the back support.

19. The infant carrier of claim 14 wherein said far shoulder strap includes a front section resting against the chest of said individual and a back section resting against a back section of said individual.

20. An infant carrier for carrying an infant by an individual, said infant carrier comprising:
a harness having two apertures and a back support for supporting the infant within the harness;
a near shoulder strap affixed to said harness and supported by the first shoulder of the individual, said near shoulder strap adjustable in length; and
a far shoulder strap affixed to said harness and supported by the second shoulder of the individual, said far shoulder strap being adjustable in length by the individual while carrying the infant;
said far shoulder strap having a frontal section resting upon the chest region of the individual and a back region resting on a back region of the individual;
the infant being supported along the hip of the individual and by said near shoulder strap upon the first shoulder and said far shoulder strap upon the second shoulder.
